(19) United States
(12) Patent Application Publication
(10) Pub. No.: US 2001/0037306 A1
(43) Pub. Date: Nov. 1, 2001

(54) Customer information collection method and system

(75) Inventor: Shuzo Yoshii, Tokyo, JP (US)

Correspondence Address: KODA & ANDROLIA, 2029 Century Park East. Suite 3850, Los Angeles, CA, 90067-3024, US

(73) Assignee: GAIAX CO., LTD

(21) Appl. No.: 09/754,625

(22) Filed: Jan. 4, 2001

(30) Foreign Application Priority Data
Apr. 26, 2000 (JP) 00126132

(51) Int. Cl. G06F 17/60; H04K 1/00; H04L 9/00

(52) U.S. Cl. 705/54; 705/55; 705/10

(57) ABSTRACT

A customer information collection method in which personal information of an individual who intends to download and use digital information is collected as customer information by a third party other than such an individual as a result of said third party acquiring the right to use the digital information, and the method comprising the steps of receiving an indication of a desire to use the digital information from the individual, prompting such an individual who has indicated the desire to input his/her own personal information as customer information, collecting and compiling such an inputted customer information, and transmitting a password is to the individual who has sent his/her own personal information to the third party so that such an individual can download and use the desired digital information.

### BACKGROUND OF THE INVENTION

1. Field of the Invention

The present invention relates to a customer information collection method and system and more particularly to a customer information collection method and system in which personal information of an individual who downloads and uses digital information such as shareware, digital contents, etc. is collected by a third party who acquires the right to use the customer information.

2. Prior Art

For companies that supply products to the marketplace, customer information has commercial value by itself. Conventionally, questionnaires are utilized as a means of collecting customer information. Methods used to distribute such questionnaires can be divided into two main categories: methods that use the mail, and methods that use electrical communications means such as the Internet, etc.

In methods that use the mail, a customer who has purchased a product (including the right to use digital information) enters specified items (customer information) on a postcard that comes with the product and then returns (mails) this postcard to the seller of the product. This customer information includes information concerning the customer himself, e.g., name, age, gender, address, occupation, etc. and also information given by the customer concerning the product. By collecting such customer information from numerous customers and analyzing this information, companies obtain valuable suggestions for the marketing of subsequent products of the same type.

Methods that use electrical communication means include questionnaires that are distributed via telephone, fax, Internet, etc. In such methods, the collected information is compiled and analyzed more efficiently than in the case that uses postcards, etc., especially when the questionnaires are distributed via the Internet, and the information can be formed into a database.

However, such conventional customer information collection methods involve some problems.

First of all, in both methods that send postcards through the mail and methods that utilize electrical communications means, the reliable collection of customer information is difficult. Returning a postcard via the mail is bothersome; as a result, postcards are sent without a response in many cases. Thus, the postcard recovery rate is usually low. The same is true in cases where the Internet is used.

Secondly, especially in cases where postcards are sent through the mail, the compilation (conversion into a database, etc.) of the collected customer information cannot be performed efficiently.

Thirdly, especially in cases where postcards are used, the amount of information that can be collected from the customers tends to be limited. Ordinarily, specified questions are entered beforehand in the limited space on the back of a postcard, and an attempt is made to obtain responses to these questions. It is physically difficult for the number of questions to reach several tens of questions.

Fourthly, especially in cases where postcards are used, the cost of mailing the postcards is ordinarily borne by the party collecting the information as a cost of collecting customer information. Thus, the customer information collection becomes costly.

Furthermore, when a questionnaire is distributed, the trouble of distributing the questionnaire to the purchaser separated from the product via a postcard or e-mail, etc. is involved. In addition, since the time of the questionnaire is not necessarily linked to the time of purchase or use of the product, in other words, since the questionnaire may be distributed after a long period of time has passed following the use of the product, there may be problems in terms of the reliability or accuracy of the information.

Meanwhile, when an individual who downloads shareware onto his/her own computer from shareware owners via an electrical communications means such as the Internet, etc., it has conventionally been necessary for such an individual to acquire a password. With the password, the individual (or the potential shareware user) pays the fee for the shareware and obtain the right to use the shareware. Accordingly, unless one who desires to use the shareware discloses a credit card number or financial institution account number, etc. that relates to payment over the Internet, or unless an individual who wishes to download a shareware goes to a financial institution such as a bank, post office, etc. and makes payment, it is not possible to obtain the password required for downloading.

In the past, there are several methods for acquiring passwords for the use of shareware.

In the first method, an individual who intends to download and use the shareware enters into an arrangement with a credit firm in which, in accordance with an agreement between such an individual and a credit firm, the individual sends a credit card verification number over the Internet together with an indication of his/her desire to purchase the shareware; the credit firm who is a party to such an agreement collects the shareware fee from; and this fee is sent to the shareware owner by this credit firm. The individual thus obtains a password so as to be able to download the shareware.

In the second method, a person who intends to download and use shareware subscribes to a provider that is an Internet connection company, sends his/her membership information over the Internet together with an indication of the his/her desire to purchase the shareware so that the shareware fee is billed as an addition to his/her connection fee, the shareware fee subsequently is remitted to the shareware. As a result, the person who intends to download and use the particular shareware obtains his/her password so as to download the shareware.

In the third method, an individual who intends to download and use the shareware pays the shareware fee by purchasing a prepaid card for the Internet at a convenience store, etc., so that such an individual or the potential shareware user can obtain the password and download the shareware.

In the fourth method, an individual who intends to download and use the shareware visits a financial institution such as a bank, post office, etc. and pays the shareware fee via this financial institution, thus obtaining the password to download the shareware.

However, in the above first and second methods, there is an inherent security problem in which the credit card verification number or membership information must be sent via the Internet in accordance with the agreement with the credit firm or the provider. The third and fourth methods are inconvenient since the person who intends to download and use the shareware must visit a convenience store, financial institution, etc. in order to pay the shareware fee.

Furthermore, in addition to the case of downloading shareware, a password must also be acquired when digital contents that involve a fee such as graphics files, audio files, digital books, still images, etc. are downloaded via the Internet. Thus, there are similar problems and inconvenience Moreover, in addition to shareware and digital contents for which a fee must be paid, there is also free digital information that can be downloaded via the Internet if a password is acquired at the time of downloading. In such cases as well, since the acquisition of a password is required, similar problems and inconvenience are encountered.

In addition, digital information also includes those stored in a memory medium such as a CD, etc. and are directly downloaded by individuals via their own personal computers. However, such information requires the acquisition of a password at the time of downloading. Similar problems and inconvenience are thus encountered.

In the present specification, the term “digital information” is used in a broad sense. It includes both shareware and digital contents, which may be free or which may require the payment of a fee.

### SUMMARY OF THE INVENTION

The inventors of the present application noted the problems and inconvenience that are encountered by individuals, who wish to download digital information, in acquiring a password and, as a result, devised the present invention.

The object of the present invention is to provide a customer information collection method and system. The invention eliminates the problems and inconvenience that are encountered by an individual who intends to download and use digital information via the Internet, etc, when such an individual acquires a password. Also, the invention makes it possible to collect and analyze large amounts of reliable customer information in a secure and efficient manner and at a low cost.

In order to accomplish the objects, the present invention provides a customer information collection method in which a personal information of an individual who intends to download and use digital information is collected as customer information by a third party other than such an individual by way of that such a third party acquires the right to use the digital information; and the method of the present invention comprises: a step in which an indication of a desire to use the digital information is received from such an individual, a step in which the individual who has indicated the desire is prompted to input his/her own personal information as customer information, a step in which this input customer information is collected and compiled, and a step in which a password is sent to the individual who is a potential user of the shareware so that the such an individual can download and use the digital information.

It is preferable that the digital information be downloaded by the individual or the potential user via an electrical communications means.

It is also preferable that the customer information includes at least information concerning the name, age, gender and e-mail address of the individual who wish to download a shareware.

It is further desirable that the method includes a step in which the collected customer information data is processed, and a database is formed and controlled.

The present invention also provides a customer information collection system in which personal information of an individual who intends to download and use digital information is collected as customer information by a third party other than such an individual by way of that such a third party acquires the right to use the digital information; and the customer information collection system of the present invention includes: a means which receives an indication of a desire to use the digital information from the individual, a means which prompts such an individual who has indicated the desire to input his/her own personal information as customer information, a means which collects and compiles this input customer information, and a means which sends a password to the individual or the potential user so that such an individual can download and use the digital information.

### BRIEF DESCRIPTION OF THE DRAWINGS

FIG. 1 is a block diagram which illustrates a customer information collection system according to one embodiment of the present invention;

FIG. 2 is a flow chart of the processing operation of the customer information processing device used in the system shown in FIG. 1; and

FIG. 3 shows the input screen on which an individual inputs his/her own personal information which is a customer information.

### DETAIED DESCRIPTION OF THE PREFERRED EMBODIMETNS

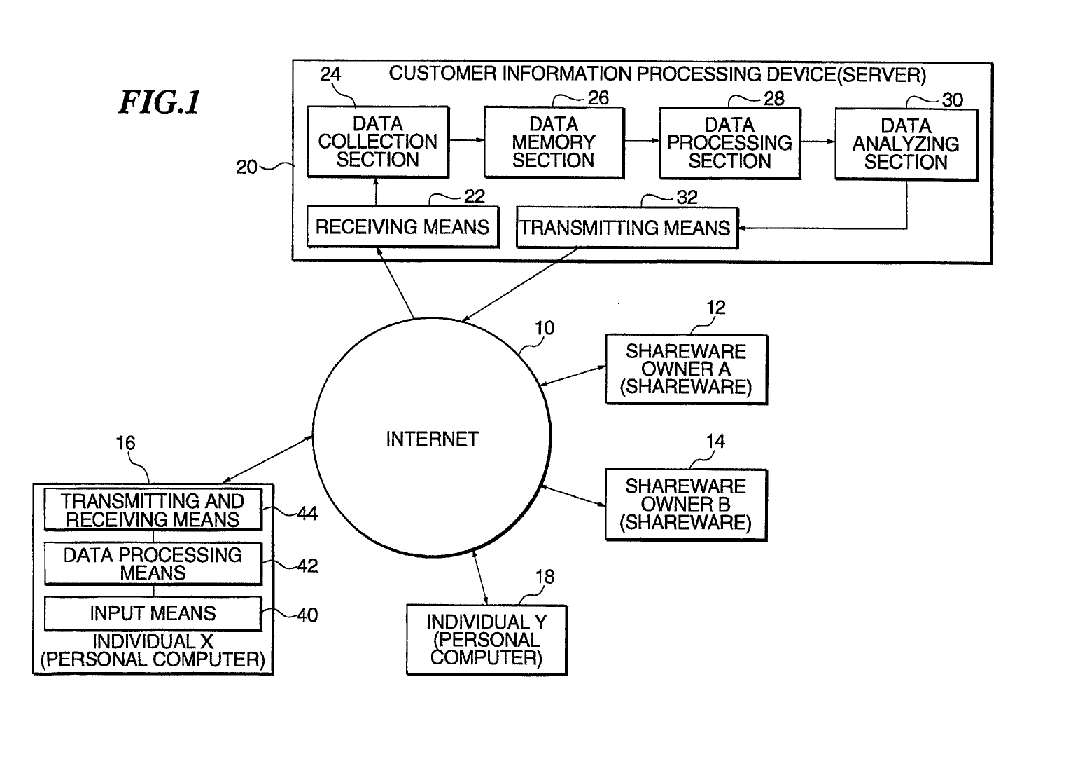

An embodiment of the present invention will be described below with reference to FIGS. 1 through 3.

The overall customer information collection system will be first described with reference to FIG. 1.

The respective computers 12 and 14 of one or more shareware owners A and B (the embodiment in FIG. 1 is described with reference to two owners A and B) are connected to the Internet 10 so that these shareware owners A and B can provide their own shareware to persons who use the shareware. Furthermore, the personal computers 16 and 18 of numerous individuals or potential shareware users X and Y (in the embodiment of FIG. 1, two potential users X and Y are illustrated) who desire to use the shareware are also connected to the Internet 10. A customer information processing device (server) 20 which is operated by a third party who collects customer information (personal information) concerning such individuals or the potential shareware users by paying the use fee (shareware use permission fee) to the shareware owners instead of the potential shareware users is also connected to the Internet 10.

The individuals or the potential shareware users X and Y can download the shareware on their own personal computers 16 and 18 via the Internet 10 by inputting their passwords supplied by the third party or the server 20.

As will be described later, the individuals or the potential shareware users X and Y acquire the necessary password by sending specified customer information (personal information) to the customer information processing device 20 operated by the third party (the server) instead of sending the shareware use fee to the shareware owners A and B.

The customer information processing device 20 comprises: a receiving means 22 that receives an indication of the desire to use specified shareware, and personal information constituting customer information, from the personal computers 16 and 18 of the individuals X and Y; a data collection section 24 that collects the personal information that is received; a data memory section 26 which stores data concerning customer information collected by the data collection section 24; a data processing section 28 which processes the stored data; a data analyzing section 30 which analyzes the processed data according to the intended use; and a transmitting means 32 which transmits the analyzed customer information to specified persons including the shareware owners. The transmitting means 32 transmits input tables for the personal information that is to be inputted to the personal computers 16 and 18 of the individuals X and Y.

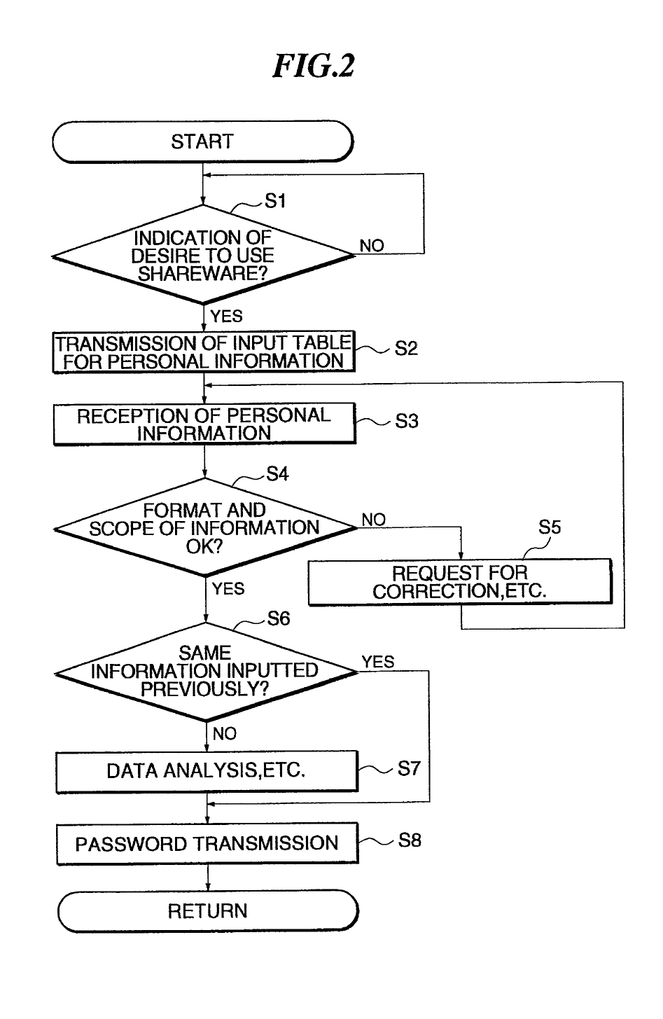

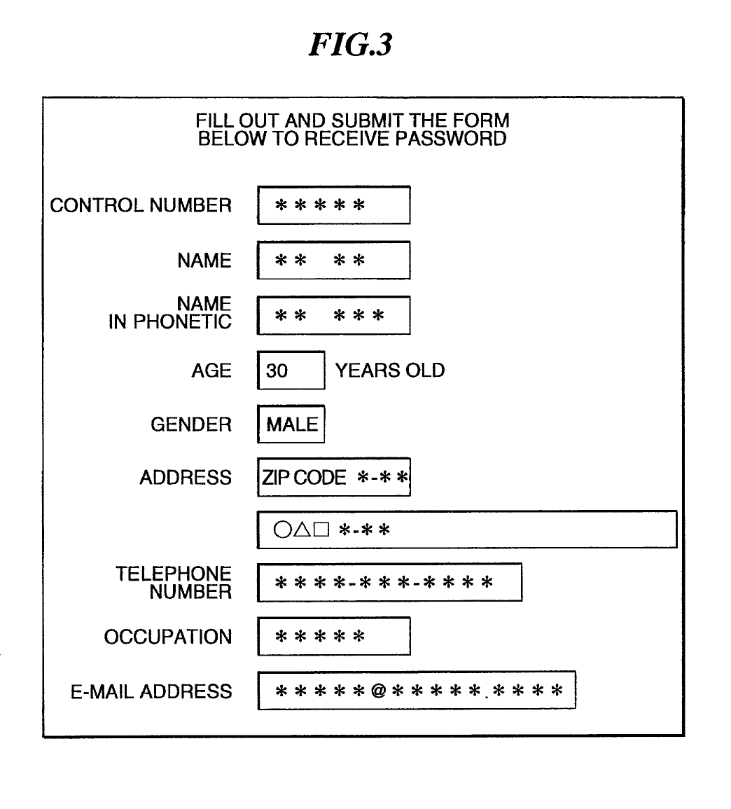

The operation of the above customer information collection system (i.e., the customer information collection method) will be described below with reference to FIGS. 2 and 3.

In FIG. 2, “S” indicates the respective processing steps that are executed by the customer information processing device 20.

First, as shown in FIG. 2, an example will be described in which an individual or a potential shareware user X wishes to download and use specified shareware of the shareware owner A onto his/her own personal computer 16 via the Internet 10. The potential shareware user X indicates a desire to use shareware via the input means (keyboard, etc.) 40 of his/her own personal computer 16. This indication of intent is sent over the Internet 10 to the customer information processing device 20 via the data processing means 42 and transmitting and receiving means 44 of the personal computer 16.

When the indication of intent is received (see step S1), the customer information processing device 20 transmits the input table for personal information constituting customer information (see FIG. 3) over the Internet 10 to the individual X who has made the indication of intent (see step S2). The individual X who receives this input table inputs his/her own personal information (constituting customer information) as shown in FIG. 3. The customer information includes control number, name of the customer, age, gender, address, telephone number, occupation, e-mail address, etc.

The individual X transmits the above-described input personal information to the customer information processing device 20 via the Internet 10, and the customer information processing device 20 receives the personal information that constitutes customer information (see step S3). The customer information processing device 20 judges whether or not the received personal information (customer information) has a specified format and scope (see step S4). In cases where the personal information does not have the specified format or scope, then correction or additional input from the individual X is requested (see step S5). In cases where the personal information has the specified format and scope, then the customer information processing device 20 checks whether or not the same customer information has been previously inputted (see step S6).

In cases where the same information has not been previously inputted, the received personal information is collected by the data collection section 24 as described above, and data concerning the customer information collected by this data collection section 24 is stored by the data memory section 26. The stored data is processed by the data processing section 28, and this processed data is subjected to a series of processing steps such as analysis according to the intended use, etc. by the data analyzing section 30 (see step S7). In this way, the collected customer information data is processed, a database is constructed, and the database is controlled. Then, the customer information processing device 20 sends the password required for downloading to the individual X who will becomes a shareware user via the Internet 10.

When the individual X who has thus acquired the password inputs the password into his/her own personal computer 16, this password is transmitted to the computer 12 of the shareware owner A via the Internet 10. Afterward, the individual X downloads the desired shareware into his/her own personal computer 16 from the computer 12 of the shareware owner A via the Internet 10.

The use fee for the shareware (shareware use permission fee) is, in accordance with the number of passwords issued, paid to the shareware owner by the customer information processing device 20 that has obtained the customer information.

As seen from the above, in the present invention, individuals acquire the passwords, which are needed for downloading, by supplying their own personal information (constituting customer information) to a customer information processing device operated by a third party, instead of paying the shareware use fee. Accordingly, there are no security problems as in conventional methods, and the inconvenience involved in obtaining a password can be eliminated. Furthermore, a third party who operates the customer information processing device can reliably collect valuable customer information in return for paying a shareware use fee (use permission fee) to the shareware owners. Since this collected customer information data is stored in database, this information can be provided to persons who wish to obtain this customer information, either with or without compensation.

The present invention is not limited to the embodiments described above. It can be used in various applications. For example, the above embodiment involves the use of shareware for which a fee is charged. However, besides such shareware, the present invention is applicable to cases where digital contents, for which a fee is charged, such as graphic files, audio files, digital books, still images, etc., are downloaded via the Internet.

Furthermore, also in cases where specified free digital information (including shareware and graphics files, etc.) is to be downloaded via the Internet and used, such free digital information can be used when individuals send personal information (constituting customer information) to a customer information processing device operated by a third party as descried in the above embodiment.

Furthermore, the “digital information” above includes information which is stored in a memory medium such as a CD, etc. and which is directly downloadable via the personal computer of an individual by setting this memory medium in a personal computer. In some cases, a password must be obtained in order to download such digital information. In such cases, the present invention is applicable. Individuals can obtain their own required password by sending personal information (constituting customer information) over the Internet to a customer information processing device operated by a third party; and after that individuals download the digital information stored in the memory medium.

As described above in detail, the customer information collection method and system of the present invention eliminates the problems and inconvenience involved in acquiring of passwords by individuals who intend to use digital information when downloading the digital information. Also, with the present invention, a large quantity of reliable customer information can be collected in a secure and efficient manner and at a low cost.

What is claimed is:

1. A customer information collection method in which personal information of an individual who downloads and uses digital information is collected as customer information by a third party other than said individual as a result of said third party acquiring rights to use said digital information, said customer information collection method comprising the steps of:
receiving an indication of a desire to use digital information from an individual,
prompting said individual who has indicated said desire to input his/her own personal information as customer information,
collecting and compiling said input customer information, and
sending a password to said individual so that said individual can use said digital information.

2. The customer information collection method according to claim 1, wherein said digital information is downloaded by said individual via an electrical communications means.

3. The customer information collection method according to claim 1, wherein said customer information includes at least information concerning the name, age, gender and e-mail address of said individual.

4. The customer information collection method according to claim 1, further comprising a step in which a collected customer information data is processed, and a database is constructed and controlled.

5. A customer information collection system in which personal information of an individual who downloads and uses digital information is collected as customer information by a third party other than said individual as a result of said third party acquiring rights to use said digital information, said customer information collection system comprising:
a means which receives an indication of a desire to use digital information from an individual,
a means which prompts said individual who has indicated said desire to input his/her own personal information as customer information,
a means which collects and compile said customer information inputted, and
a means which sends a password to said individual so that said individual can use said digital information.

6. The customer information collection system according to claim 5, wherein said digital information is downloaded by said individual via an electrical communications means.

7. The customer information collection system according to claim 5, wherein said customer information includes at least information concerning the name, age, gender and e-mail address of said individual.

8. The customer information collection method according to claim 5, further comprising a means in which a collected customer information data is processed, and a database is constructed and controlled.
